(19) United States
(12) Patent Application Publication
(10) Pub. No.: US 2020/0109244 A1
(43) Pub. Date: Apr. 9, 2020

(54) PEELABLE POLYIMIDE COMPOSITE FILM

(71) Applicant: TAIMIDE TECH. INC., Hsinchu (TW)

(72) Inventors: Yi-Chia Huang, Hsinchu (TW); Meng-Ying Tsai, Hsinchu (TW); Paul S. C. Wu, Hsinchu (TW)

(21) Appl. No.: 16/592,845

(22) Filed: Oct. 4, 2019

(30) Foreign Application Priority Data
Oct. 5, 2018 (TW) 107135227

(51) Int. Cl. C08J 5/18; C08G 73/10

(52) U.S. Cl. CPC C08J 5/18; C08J 2379/08; C08G 73/1071

(57) ABSTRACT

A peelable polyimide composite film includes a first polyimide film having a first surface and a second surface opposite to each other; and a second polyimide film attached to the first surface of the first polyimide film A difference in coefficient of thermal expansion between the first polyimide film and the second polyimide film is greater than or equal to 9 um/m° C., so that the first polyimide film and the second polyimide film can be peeled off from each other.

### CROSS-REFERENCE TO RELATED PATENT APPLICATION

This application claims the benefit of priority to Taiwan Patent Application No. 107135227, filed on Oct. 5, 2018. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a peelable polyimide composite film, and in particular, to an ultra-thin polyimide film.

### BACKGROUND OF THE DISCLOSURE

In a printed circuit board, in order to protect a metal circuit, a polyimide coverlay is generally disposed thereon. With the technological development and product requirements, the printed circuit board has been developed toward being light and thin in size, and multi-functional. Reducing the overall thickness of the printed circuit board is also an important goal of development in the industry. Thinning of the polyimide coverlay has become one of the important aims in the overall design of printed circuit boards.

However, due to the limited process capability of conventional polyimide films, ultra-thin polyimide films are difficult to be developed. It is known that the thickness of the commercially available thinnest polyimide coverlay may be less than 10 μm. However, it is almost impossible to prepare a polyimide film of less than 5 μm by the existing biaxial stretching process. Moreover, it is also necessary to consider the problem of the operability of adhesive coating in downstream application.

Accordingly, there is still a need for an ultra-thin polyimide film product and related process thereof.

### SUMMARY OF THE DISCLOSURE

The present disclosure provides a peelable polyimide composite film, including a first polyimide film having first and second surfaces opposite to each other; and a second polyimide film attached to the first surface of the first polyimide film. A difference in coefficient of thermal expansion (CTE) between the first polyimide film and the second polyimide film is greater than or equal to 9 um/m° C., so that the first polyimide film and the second polyimide film can be peeled off from each other.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

FIG. 1 is a sectional view of a peelable polyimide composite film of the present disclosure.

FIG. 2 is a schematic view of the peelable polyimide composite film of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

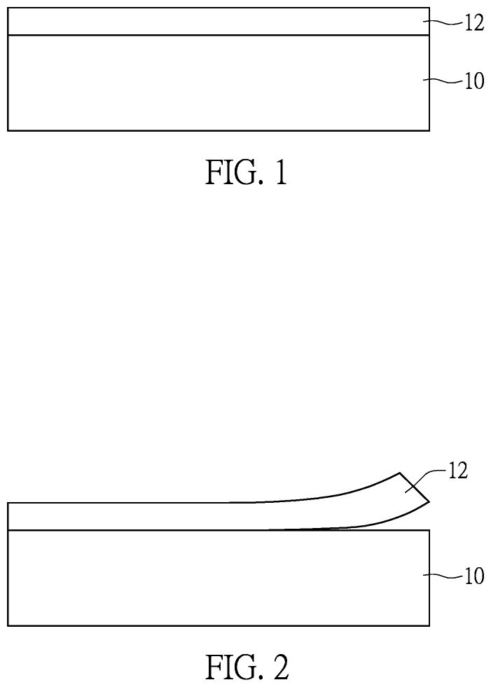

In this example, referring to FIG. 1, a first polyimide film 10 has a thickness of 6 μm or less, preferably 5 μm or less, for example, 0.1-5 μm. In an example, the first polyimide film 10 may have a thickness of 0.1, 1, 2, 2.5, 3, 4, 4.5 μm, or a value between any two of the foregoing values.

The thickness of a second polyimide film 12 is not particularly limited, and can apply the thickness of a general polyimide film. In some examples, the second polyimide film 12 has a thickness of 5-50 μm. In some examples, the second polyimide film 12 may have a thickness of 20 μm or more.

Referring to FIG. 2, a difference in CTE between the first polyimide film 10 and the second polyimide film 12 is greater than or equal to 9 um/m° C., so that the first polyimide film 10 and the second polyimide film 12 can be peeled off from each other.

If necessary, a biaxial stretching treatment can be further performed after the first polyimide film 10 and the second polyimide film 12 are formed, so that the strength of the polyimide films 10 and 12 can be enhanced. The thinner the thickness of the polyimide film is, the more difficult it is to perform the biaxial stretching treatment. Therefore, it is known that the currently commercially available ultra-thin polyimide film can hardly be biaxially stretched in the process, and an adverse effect to the film strength is caused. However, since the first polyimide film 10 is directly formed on the second polyimide film 12 in the polyimide composite film of the present disclosure, the biaxial stretching treatment can be performed as needed without adversely affecting the thin film, such as causing ruptures.

The polyimide composite film of the present disclosure can be formed by thermal conversion or chemical conversion. If chemical conversion is employed, a dehydrating agent and a catalyst can be added to the polyamic acid solution prior to a coating step. The solvent, the dehydrating agent, and the catalyst used are known in the art. The solvent may be an aprotic polar solvent such as dimethylacetamide (DMAC), N,N′-dimethylformamide (DMF), N-methylpyrrolidone (NMP), dimethylsulfoxide (DMSO), tetramethyl sulfone, N,N′-dimethyl-N,N′-propylene urea (DMPU), and the like. The dehydrating agent may be aliphatic anhydride (such as acetic anhydride and propionic anhydride), aromatic anhydride (such as benzoic anhydride and phthalic anhydride), and the like. The catalyst may be heterocyclic tertiary amine (such as picoline and pyridine), aliphatic tertiary amine (such as triethylamine (TEA)), aromatic tertiary amine (such as xylidine), and the like. The molar ratio of polyamic acid:dehydrating agent:catalyst is 1:2:1, that is, about 2 moles of the dehydrating agent and about 1 mole of the catalyst are used per mole of polyamic acid.

In the present disclosure, a diamine monomer and a dianhydride monomer are subjected to a condensation reaction to form polyimide, and the diamine and the dianhydride are reacted at about an equimolar ratio (1:1), such as 0.9:1.1, or 0.98:1.02.

The polyimide constituting the main structure of the peelable base layer and the polyimide of the polyimide layer are not particularly limited.

In an example, the diamine monomer may be 4,4′-oxydianiline (ODA)), phenylenediamine (p-PDA), 2,2′-bis(trifluoromethyl)benzidine (TFMB), 1,3-bis(4′-aminophenoxy)benzene (TPER), 1,4-bis(4-aminophenoxy)benzene (TPEQ), 2,2′-dimethyl[1,1′-biphenyl]-4,4′-diamine (m-TB-HG), 1,3′-bis(3-aminophenoxy)benzene (APBN), 3,5-diaminobenzotrifluoride (DABTF), 2,2′-bis[4-(4-aminophenoxy)phenyl]propane (BAPP), 6-amino-2-(4-aminophenyl)benzoxazole (6PBOA), 5-amino-2-(4-aminophenyl)benzoxazole (SPBOA), and the like, which can be used alone or in combination.

In an example, the dianhydride monomer may be 3,3′,4,4′-biphenyltetracarboxylic dianhydride (BPDA), 2,2-bis[4-(3,4-dicarboxyphenoxy)phenyl]propane dianhydride (BPADA), pyromellitic dianhydride (PMDA), (2,2′-bis-(3,4-dicarboxyphenyl) hexafluoropropane dianhydride (6FDA), 4,4-oxydiphthalic anhydride (ODPA), benzophenonetetracarboxylic dianhydride (BTDA), 3,3′,4,4′-dicyclohexyltetracarboxylic acid dianhydride (HBPDA), and the like, which may be used alone or in combination.

In some examples, the monomer of the first polyimide film 10 includes the following components. The diamine may be ODA, p-PDA, or TFMB, which may be used alone or in combination. The dianhydride may be PMDA, BPDA, or BPADA, which may be used alone or in combination.

In an example, the first polyimide film 10 may use a monomer which is identical to, partially identical to, or different from that of the second polyimide film. In some examples, the diamine used in the second polyimide film 12 may be ODA, p-PDA, or TFMB, which may be used alone or in combination, and the dianhydride may be PMDA, BPDA, or BPADA, which may be used alone or in combination.

### Example 1

The desired diamine ODA monomer is first added to a DMAc solvent, stirred and dissolved. Then, the dianhydride PMDA monomer is slowly added to the solution to increase the viscosity of the solvent to 160,000 cps, and finally the solid content thereof is controlled at about 18%, which is the formulation of the first polyimide film. The diamine monomers in the formulation of the second polyimide film are ODA and PDA having a ratio of 80:20, respectively, and the dianhydride monomer is PMDA.

### Example 2

In this example, the desired diamine ODA monomer is first added to a DMAc solvent, stirred and dissolved. Then the dianhydride PMDA monomer is slowly added, and the viscosity of the solvent will continue to rise to about 160,000 cps after the addition of PMDA, and the solid content is finally controlled at about 18%, which is the formulation of the first polyimide film. The diamine monomers in the formulation of the second polyimide film are ODA and PDA having a ratio of 70:30, respectively, and the dianhydride monomer is PMDA.

### Example 3

The formulation of the first polyimide film 10 in this example includes ODA and PMDA, and the polymerization process is the same as the foregoing example. The formulation of the second polyimide film includes a diamine monomer and a dianhydride monomer, i.e., TFMB and 6FDA, respectively.

### Comparative Example

The formulation of the first polyimide film 10 in the comparative example is composed of ODA and PMDA as in the examples. The diamine monomers in the formulation of the second polyimide film are ODA and PDA having a ratio of 85:15, respectively, and the dianhydride monomer is PMDA.

The test results of the examples and the comparative example show that when the difference in CTE between two polyimide films is greater than 9 um/m° C., the adhesion of the two polyimide films can be reduced, so that the two polyimide films can be peeled off from each other. Therefore, the present disclosure can control whether the product can be peeled off or not according to the difference in CTE between two polyimide films on the basis of the polyimide films of the same thickness. The peelable polyimide films enable subsequent processes such as gluing to be easily controlled, thereby improving the product yield.

Table 1 shows the results of the peelability evaluation for the ratio of the diamine monomers of the first polyimide film and the second polyimide film, and it is found from the results that the peelable effect can be achieved by changing the diamine monomers to cause a difference in CTE and controlling the difference in CTE between the two layers at above 9 um/m° C.

TABLE 1
Evaluation of the peeling ability of the first polyimide film and the second polyimide film

| | First | Second | CTE of the | CTE of the | | |
|---|---|---|---|---|---|---|
| | polyimide film | polyimide film | first | second | | |
| | PMDA/BPDA// | PMDA/BPDA// | polyimide film | polyimide film | ΔCTE | Peelability |
| | ODA/PDA | ODA/PDA | um/m ° C. | um/m ° C. | — | Y/N |
| Example 1 | 100/0//100/0 | 100/0//85/15 | 34 | 25 | 6 | N |
| Example 2 | 100/0//100/0 | 100/0//85/15 | 34 | 25 | 9 | Y |
| Example 3 | 100/0//100/0 | 100/0//85/15 | 34 | 62 | 16 | Y |
| Comparative | 100/0//100/0 | 6FDA/TFMB | 34 | 27 | 7 | Y |
| example | | | | | | |

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A peelable thin polyimide composite film, comprising:
a first polyimide film having a first surface and a second surface; and
a second polyimide film attached to the first surface of the first polyimide film, wherein a difference in thermal expansion coefficient between the first polyimide film and the second polyimide film is greater than 9 um/m° C., so that the first polyimide film and the second polyimide film are able to be peeled off from each other.

2. The peelable thin polyimide composite film according to claim 1, wherein the first polyimide film is formed by reacting diamine selected from the group consisting of 4,4′-oxydianiline (ODA) and phenylenediamine (PDA), and dianhydride selected from the group consisting of pyromellitic dianhydride (PMDA) and 3,3′,4,4′-biphenyltetracarboxylic dianhydride (BPDA).

3. The peelable thin polyimide composite film according to claim 1, wherein the second polyimide film is formed by reacting diamine selected from the group consisting of ODA and PDA, and dianhydride selected from the group consisting of PMDA and BPDA.
